(19) United States
(12) Patent Application Publication
(10) Pub. No.: US 2002/0047687 A1
(43) Pub. Date: Apr. 25, 2002

(54) Battery charger with energy level gauge

(76) Inventor: Ming-Ta Chen, Taipei Hsien (TW)

Correspondence Address: Michael D. Bednarek, SHAWPITTMAN, 2300 N. Street, N.W., Washington, DC, 20037-1128, US

(21) Appl. No.: 09/761,755

(22) Filed: Jan. 18, 2001

(30) Foreign Application Priority Data
Oct. 25, 2000 (TW) 089122487

(51) Int. Cl. H02J 7/00

(52) U.S. Cl. 320/132

(57) ABSTRACT

This invention relates to a battery charger with an energy level gauge, being disposed in a portable data processing device for coupling to and charging a chargeable battery pack, comprising: a charger electrically coupled between the power supply and the chargeable battery pack for charging the chargeable battery pack; an energy level gauge being built in the charger for detecting the remaining capacity of the chargeable battery pack. The remaining capacity of the chargeable battery pack is input into the portable data processing device and the current detecting circuit, and said energy level gauge is electrically coupled between the power supply and the energy level detecting circuit for charging the chargeable battery pack. Therefore, it only needs to add an additional circuit during the manufacture of the charging circuit within the main system in order to attain the function of monitoring the battery charge level.

### BACKGROUND OF THE INVENTION

1. Field of the Invention

This invention relates to a batter7y charger of a notebook computer, and more particularly to a battery charger with an energy level gauge.

2. Description of the Related Art

Portable devices such as notebook computers or personal digital assistants (PDA), etc. tend to develop in the trend of low cost and high performance. In general, a portable device usually comes with a chargeable battery pack facilitating users in carrying as well as for repeated use. Since the chargeable battery pack will be damaged easily if it is overcharged, therefore in order to protect a battery pack and elongate the battery life, an energy level gauge is set within the battery pack to monitor the relevant information such as the remaining capacity of the battery pack and the electricity percentage for determining whether or not the battery charger should continue its charging. In FIG. 1, it shows a conventional notebook architecture, wherein the notebook computer comprises a conventional main system 11, and a conventional battery compartment 10. The conventional battery compartment 10 has a battery pack 101 and an energy level gauge 102. The battery pack 101 is a rechargeable battery, which is usually a Lithium Ion-Hydrogen or a Nickel metal-Hydrogen rechargeable battery, and the battery level gauge 102 is built in the conventional battery compartment 10 for detecting the remaining capacity of the battery pack and passing the detected result back to the conventional main system 11. The architecture of the conventional main system 11 is similar to that of the notebook computer comprising a basic input/output system (BIOS) 111, a keyboard (K/B) 112, a charger 113, and a system management bus (SM bus) 114; wherein the energy level gauge 102 passes the detected data back to the conventional main system 11 through the conventional battery compartment 10, so that it can tell the charging status in the battery compartment 10, and helps us to determine whether or not we should continue the battery charge.

FIG. 1 also describes the connection between the conventional notebook computer and the battery compartment. The SM bus 114 as shown in FIG. 1A is coupled to and between the keyboard 112 and the charger 113, and the SM bus 114 as shown in FIG. 1B is coupled to and between the basic input/output system 111 and the charger 113. The difference between these two ways lies on the simple and easy built-in architecture of the conventional main system 11 as shown in FIG. 1A having a higher cost, and the architecture as shown in FIG. 1B has a lower cost, but the BIOS 111 demands more ROM from the CPU and hence reduces the overall system performance.

FIG. 2 describes another conventional embodiment of the notebook computer and the battery compartment, and its architecture is similar to that of the one shown in FIG. 1A, and the difference lies on the conventional battery compartment, in which the energy level gauge 102 is substituted by an electrically erasable programmable read only memory (EEPROM) 103. The information of the remaining capacity of the battery pack 101 in the battery compartment 10 is saved in the EEPROM 103 of which the information is passed back to the conventional main system 11 through the SM bus 114. Such arrangement has the lowest cost, however the keyboard 112 demands a great deal of ROM from the CPU and in turn lowers the overall system performance. In addition, the keyboard 112 and the BIOS 111 of the conventional main system 11are not standard accessory equipment, and they are applicable for specific models of notebook computers only.

### SUMMARY OF THE INVENTION

The primary objective of this invention is to provide a battery charger with energy level gauge, which removes the charging detection circuit or EEPROM originally disposed inside the battery compartment in order to lower the manufacturing cost.

Another objective of this invention is to provide a battery charger with energy level gauge, which has a built-in energy level gauge being disposed within the charging circuit in the main system. Therefore, during the manufacture of the charging circuit for the main system, it only needs to add an additional circuit for the energy detection function, and therefore it will not increase the manufacturing cost of the charging circuit that much.

A further objective of the present invention is to provide a battery charger with energy level gauge, which is applicable for the architecture of the conventional notebook computers. There is no need to change the keyboard and BIOS in order to place the energy level gauge inside the notebook computer.

Another further objective of the present invention is to provide a battery charger with energy level gauge, wherein the gauge is implemented in the notebook computer architecture in the condition of not occupying the main system resources and maintaining the system performance.

The present invention is to solve the high cost and low performance problems of the conventional main system and battery compartment by using a simple energy detection circuit which is built in the battery charger of the main system to substitute the high cost of the energy level gauge attached to the battery compartment.

The present invention further provides an energy level gauge for the battery charger to enhance the operating performance of the main system.

The above is a brief description of some deficiencies in the prior art and the advantages of this invention. Other features, advantages and embodiments of the invention will be apparent to those skilled in the art from the following description, accompanying drawings and appended claims.

### BRIEF DESCRIPTION OF DRAWINGS

The following detailed description, given by way of examples and not intended to limit the invention to the embodiments described herein, will be best understood in conjunction with the accompanying drawings, in which:

FIG. 1 is a schematic diagram of a structure of the prior art notebook computer and battery compartment, and

FIG. 1A shows the first embodiment and

FIG. 1B shows the second embodiment of the prior art.

FIG. 2 is a schematic diagram of another embodiment of the structure of the prior art notebook computer and battery compartment is invention.

FIG. 3 is a schematic diagram of the battery charger with an energy level gauge according to the present invention.

FIG. 4 is a circuit block diagram of the battery charger with an energy level gauge according to the present invention.

### DETAILED DESCRIPTION OF THE INVENTION

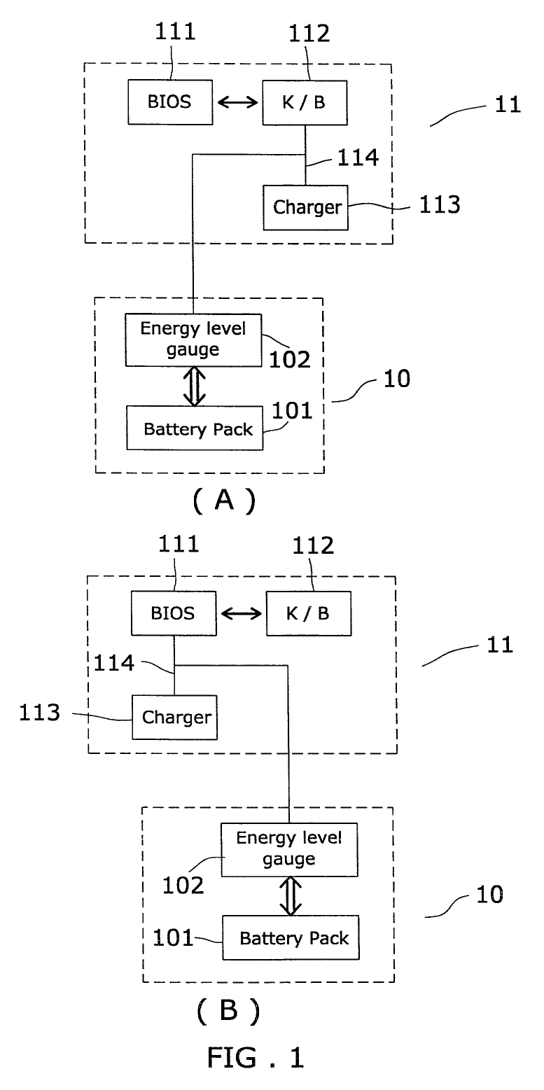

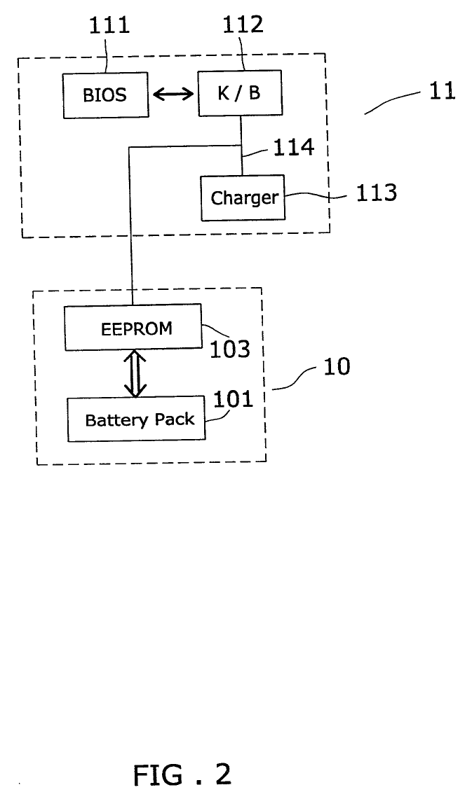

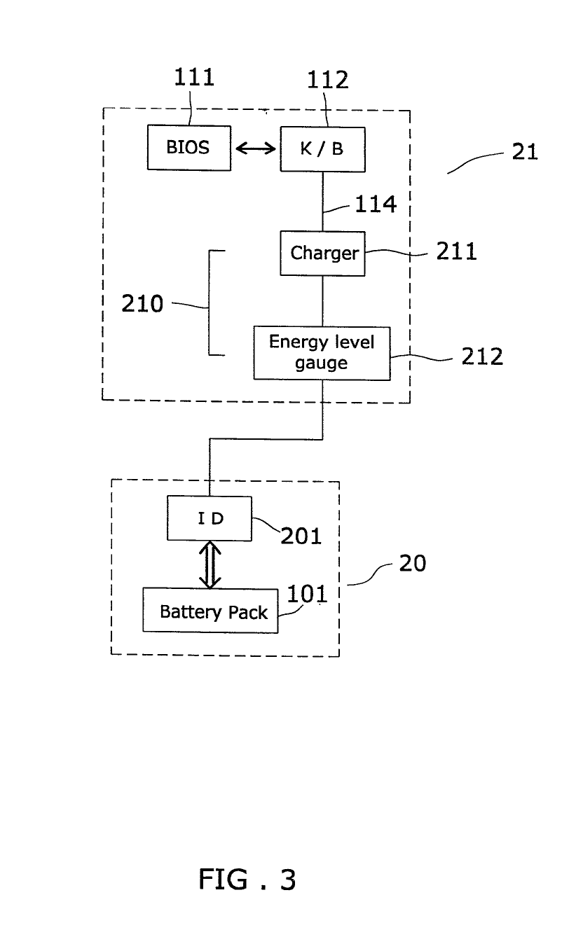

In FIG. 3, it shows a preferred embodiment of the notebook computer according to the present invention comprising a battery compartment 20 and a main system 21. The battery compartment 20 comprises a rechargeable battery 101 and an identification code 201, and the rechargeable battery 101 provides a signal to main system 21. It is worth to notice that the battery compartment 20 itself does not have any energy level gauge for detecting the current or any electrically erasable programmable read only memory (EEPROM) for storing the battery capacity status, and therefore the manufacturing cost for the components of the battery compartment 20 can be reduced drastically. The main system 21 includes a basic input/output system (BIOS) 111, a keyboard 112, a battery charger having an energy level gauge 210, and a system management bus (SM bus) 114. The present invention does not make any change on the BIOS 111, the keyboard 112, and the SM bus 114 as shown in FIG. 1A. Therefore, the present invention has a low-cost architecture of which the BIOS 111 does not need to send the output signal to the CPU for processing via the SM bus, which will lower the overall system performance. The present invention does not have such performance problem as shown in FIG. 1B. Furthermore, FIG. 2 shows another embodiment of the conventional notebook computer and battery compartment. Although its cost is minimized, the keyboard 112 will occupy the ROM space of the main system that will lower the system performance in addition to that both the keyboard and BIOS are not standard equipment of the notebook computer.

When the battery compartment 20 is installed to the main system 21, the identification code 201 is electrically coupled to the output of a battery charger 210 having an energy level detection circuit, and the information is passed to the conventional main system 11 via the SM bus 114 such that the main system 21 can tell the unique identification code 201 designated to each battery compartment 20. Noted that the identification code 201 can be a flow number of a binary code with 64 bits length or other binary code showing storage medium. Since all battery compartments 20 of the present invention do not have energy level gauge, therefore there is no way to detect the remaining capacity and the electricity percentage of the battery compartment 20 in order to report to the main system 21. To avoid battery charging for a plurality of battery compartments of the same main system 21 that will cause the main system 21 for being not able to identify different battery compartments and result in overcharging, the main system 21 can identify the battery compartment by the signal of the unique identification code 201 to confirm the status of the battery being charged.

The signal of the identification code 201 comprises a serial signal of ROM reserved for user definition in the BIOS 111or the keyboard 112. Since the serial signal is only for the identification purpose, therefore it does not occupy too much memory space of the ROM or lower the overall system performance. Of course, in another embodiment, the relevant information such as the remaining capacity and electricity percentage of the battery pack 101 will be stored with the serial signal in the BIOS 111 or in the ROM reserved for user definition of the keyboard 112.

When the main system 21 confirms the battery charge by the identification code, it simultaneously obtains the information of the remaining capacity and the electricity percentage to determine whether or not to continue the battery charge. The battery compartment 20 further comprises a temperature sensor 202 for detect the operating temperature of the battery compartment 20 so as to prevent the overheating of the battery compartment 20.

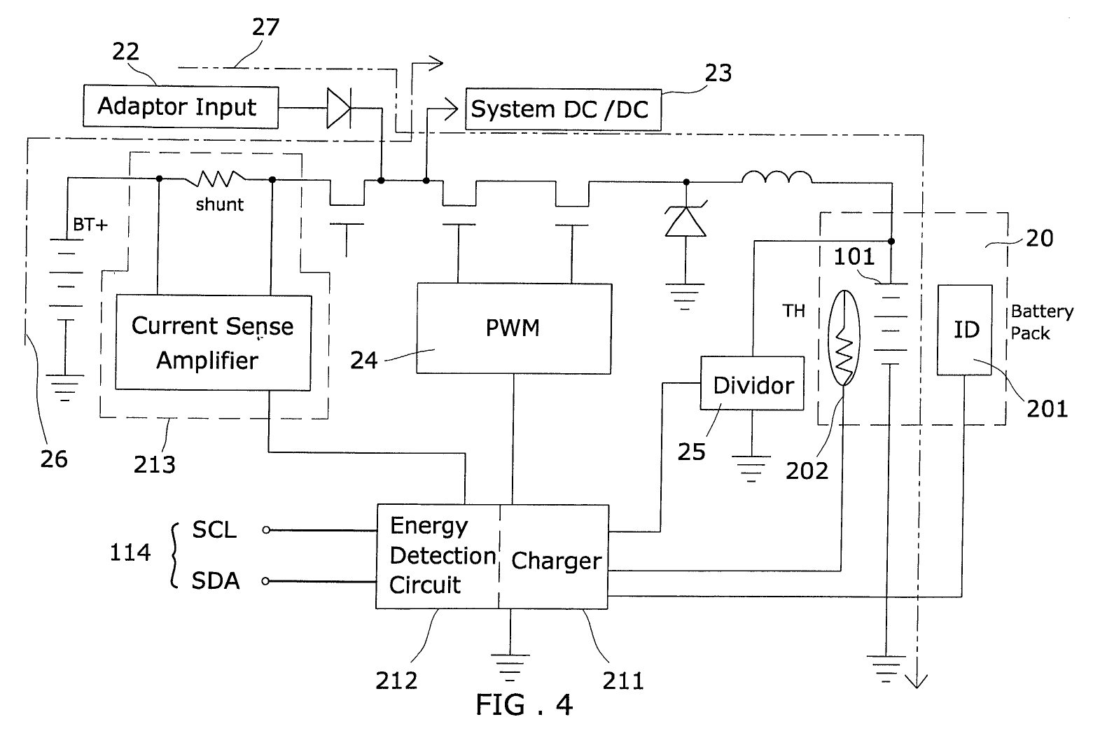

FIG. 4 is the detailed circuit block diagram showing that the main system 21 further comprises a transformer output 22, a system DC/DC converter 23, a pulse-width modulator (PWM) 24 and a shunt 25. The transformer 22 provides direct current for the operation of the main system 21, and the system DC/DC transformer 23 converts the high-voltage current into the current of appropriate voltage for the main system 21 and other components (such as central processing unit, CPU, etc.). The pulse-width modulator 24 adjust the electricity being charged to the battery pack according to the signal from the battery charger 211, and the shunt 25 is coupled between the battery charger 211 and the battery pack 101 to prevent overcharging. The path of the system discharging circuit is labeled as 26, and the path of system charging circuit is labeled as 27; such portions are the same as prior art main system and hence not described here.

When the battery compartment 20 is installed to the main system 21, the battery charger confirms the battery compartment 20 by its identification code 201. The energy detection circuit 212 can determine the remaining capacity and electricity percentage of the battery compartment 20 by the current detected by the current sensing circuit 213 or by the SCL of the SM bus 114 and the SDA directly access the relevant information of the remaining capacity and electricity percentage of the battery stored in the memory. The current sensing circuit 213 is an extension circuit before the transformer output 22 of the circuit of the main system 21, and furthermore one of its ends is coupled to the energy level detection circuit 212 and it passes back the sensed current result to the current sensing circuit 212, which comprises an oscillating resistance and current sensor amplifier. The status of being in the charging circuit path 27 or the discharging circuit path 26 is determined by the signal of the status passed back from the current sensor circuit 212. The battery charger 211 will charge the battery compartment 20 because the relevant information of the remaining capacity and electricity percentage can be accurately obtained from the battery charger 211, and therefore the battery pack 20 will not be overcharged and hence elongate the battery life.

From the above description, the battery charger having an energy level gauge according to the present invention adds an additional circuit to the existing circuit of the conventional main system 21, and therefore there is no need to change the current architecture of the main system and protocol. Furthermore, the system pulse and the system information transmitted from the SM bus 114 will not change or increase the loading of the main system 21 due to the energy level detection circuit, and hence will not lower the system performance.

While the invention has been described with reference to various illustrative embodiments, the description is not intended to be construed in a limiting sense. Various modifications of the illustrative embodiments, as well as other embodiments of the invention, will be apparent to those skilled in the art upon reference to this description. It is therefore contemplated that the appended claims will cover any such modifications or embodiments as may fall within the scope of the invention defined by the following claims and their equivalents.

What is claimed is:

1. A battery charger with energy level gauge, being set in a portable data processing device for charging a chargeable battery pack, comprising:
a charger, being electrically coupled to and between a power supply and the chargeable battery pack, for charging the chargeable battery pack;
an energy level detection circuit, being built in the charger, for detecting the remaining capacity of the chargeable battery pack, and inputting the remaining capacity of the chargeable battery pack to the portable data processing device; and
a current detection circuit, being electrically coupled to and between the power supply and the current detection circuit for examining the strength of the current and feedback the detected result to said energy level detection circuit.

2. The battery charger with energy level gauge as claimed in claim 1, wherein said chargeable battery pack has an identification code such that the portable data processing device can identify the chargeable battery pack.

3. The battery charger with energy level gauge as claimed in claim 1, wherein said current detection circuit comprises an oscillating resistor and a current detection amplifier.

4. The battery charger with energy level gauge as claimed in claim 1, wherein when said energy level detection circuit detects the predetermined maximum voltage of the chargeable battery pack, the battery charger will stop charging the chargeable battery pack.

5. The battery charger with energy level gauge as claimed in claim 1, wherein when the remaining capacity of the chargeable battery pack detected by said energy level detection circuit is higher than the predetermined maximum voltage, the battery charger will stop charging the chargeable battery pack.

6. The battery charger with energy level gauge as claimed in claim 1, wherein the system management bus (SM bus) is coupled to the basic input/output system (BIOS) of the portable data processing device.

7. The battery charger with energy level gauge as claimed in claim 1, wherein the system management bus (SM bus) is coupled to the keyboard of the portable data processing device.

8. A notebook computer, having its electricity supply selectively from a power supply or a chargeable battery pack with an identification code, comprising:
a monitor, for displaying the output image of said notebook computer;
a main system, comprising a charging circuit that is electrically coupled to and between the power supply and the chargeable battery pack for charging the chargeable battery pack; an energy level detection circuit; and a current detection circuit being electrically coupled to and between the power supply and the energy level detection circuit for detecting the strength of the current and passing the detected result back to the energy level detection circuit.

9. A notebook computer as claimed in claim 8, wherein said current detection circuit further comprising an oscillating resistance and current detection amplifier.

10. A notebook computer as claimed in claim 8, wherein when said energy level detection circuit detects a predetermined maximum voltage of the chargeable battery pack, the battery charger will stop charging the chargeable battery pack.

11. A notebook computer as claimed in claim 8, wherein when the remaining capacity of the chargeable battery pack detected by said energy level detection circuit is higher than a predetermined maximum voltage of the chargeable battery pack, the battery charger will stop charging the chargeable battery pack.

12. A notebook computer as claimed in claim 8, wherein said system management bus (SM bus) being coupled to the basic input/output system (BIOS) of said notebook computer.

13. A notebook computer as claimed in claim 8, wherein said SM bus being coupled to the keyboard of said notebook computer.
